(19) United States
(12) Patent Application Publication
(10) Pub. No.: US 2024/0351686 A1
(43) Pub. Date: Oct. 24, 2024

(54) DIVIDER SYSTEM FOR AN INTERNAL CABIN OF AN AIRCRAFT

(71) Applicant: THE BOEING COMPANY, Arlington, VA (US)

(72) Inventors: Tom Eaton, Los Angeles, CA (US); Victor Carlioz, Los Angeles, CA (US); Matthew Cleary, Los Angeles, CA (US); Andrew Greenbaum, Los Angeles, CA (US); Matteo Broccolo, Los Angeles, CA (US); Claire Nelsen, Los Angeles, CA (US)

(73) Assignee: THE BOEING COMPANY, Arlington, VA (US)

(21) Appl. No.: 18/586,790

(22) Filed: Feb. 26, 2024

Related U.S. Application Data
(60) Provisional application No. 63/497,248, filed on Apr. 20, 2023.

(51) Int. Cl. B64D 11/00

(52) U.S. Cl. CPC B64D 11/0023; B64D 11/0015

(57) ABSTRACT

An aircraft includes an internal cabin having a first section and a section, and a divider system within the internal cabin. The divider system separates the first section from the second section. The divider system includes one or more walls, and one or more electronic screens secured to the one or more walls. The the one or more electronic screens are transparent and configured to show electronic content thereon.

### CROSS-REFERENCE TO RELATED APPLICATIONS

This application is a non-provisional conversion of, and claims priority to, U.S. Provisional Patent Application No. 63/497,248, filed Apr. 20, 2023, which is incorporated by reference in its entirety.

### FIELD OF THE DISCLOSURE

Examples of the present disclosure generally relate to a divider system configured to divide different sections within an internal cabin of an aircraft.

### BACKGROUND OF THE DISCLOSURE

Vehicles such as commercial aircraft are used to transport passengers between various locations. A typical aircraft includes an internal cabin having seats for passengers.

Internal cabins of many commercial aircraft have different sections, such as a first class section, a business class section, an economy section, and/or the like. Curtains can be used to separate different sections from one another. As an example, a first class section is often set apart from other areas of the internal cabin by curtains. However, certain individuals may find the curtains to be cumbersome to manipulate, and aesthetically undesirable.

### SUMMARY OF THE DISCLOSURE

A need exists for an improved system and method for dividing sections within an internal cabin of a vehicle, such as a commercial aircraft. Further, a need exists for a system and method for providing information to passengers in different sections of an internal cabin of a vehicle.

With those needs in mind, certain examples of the present disclosure provide a divider system configured to separate a first section from a second section within an internal cabin of a vehicle. The divider system includes one or more walls, and one or more electronic screens secured to the one or more walls. The one or more electronic screens are transparent and configured to show electronic content thereon.

In at least one example, the one or more electronic screens include a transparent organic light-emitting diode (OLED) screen.

In at least one example, the one or more walls include a first wall and a second wall, and the one or more electronic screens include a first electronic screen coupled to the first wall, and a second electronic screen coupled to the second wall. Each of the first electronic screen and the second electronic screens can be a transparent OLED screen.

In at least one example, the first wall and the second wall are configured to be separated by an aisle within the internal cabin.

In at least one example, the one or more electronic screens are selectively switchable between a transparent mode and an opaque mode.

The first section can be a first class section or a business class section, and the second section can be the business class section or an economy section.

The one or more walls can be configured to extend to one or both of an overhead stowage bin or a ceiling within the internal cabin.

In at least one example, a control unit is in communication with the one or more electronic screens. The control unit is configured to control operation of the one or more electronic screens to display various types of the electronic content. The vehicle can be an aircraft. The control unit can be configured to control the one or more electronic screens based on phases of a flight of the aircraft.

### BRIEF DESCRIPTION OF THE DRAWINGS

FIG. 1 illustrates a perspective front view of an aircraft, according to an example of the present disclosure.

FIG. 2 illustrates a perspective interior view of an internal cabin of an aircraft, according to an example of the present disclosure.

FIG. 3 illustrates a perspective view of a divider system having electronic screens showing electronic content within an internal cabin of an aircraft, according to an example of the present disclosure.

FIG. 4 illustrates a perspective view a divider system having electronic screens showing different electronic content within the internal cabin of FIG. 3.

FIG. 5 illustrate a perspective front view of an electronic screen showing a message, according to an example of the present disclosure.

FIG. 6 illustrate a perspective front view of an electronic screen showing a message, according to an example of the present disclosure.

FIG. 7 illustrates a perspective view of an electronic screen, according to an example of the present disclosure.

### DETAILED DESCRIPTION OF THE DISCLOSURE

The foregoing summary, as well as the following detailed description of certain embodiments will be better understood when read in conjunction with the appended drawings. As used herein, an element or step recited in the singular and preceded by the word “a” or “an” should be understood as not necessarily excluding the plural of the elements or steps. Further, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular condition can include additional elements not having that condition.

As described herein, a vehicle, such as an aircraft, includes an internal cabin, and a divider system within the internal cabin. The divider system includes one or more walls, and one or more displays (such as electronic screens) secured to the one or more walls. The one or more displays are transparent and configured to show electronic content thereon. In at least one example, the one or more walls include a first wall and a second wall, and the one or more displays include a first display and a second display. In at least one example, each display is a transparent organic light-emitting diode (OLED) screen. In at least one example, the display(s) are selectively switchable between transparent and opaque.

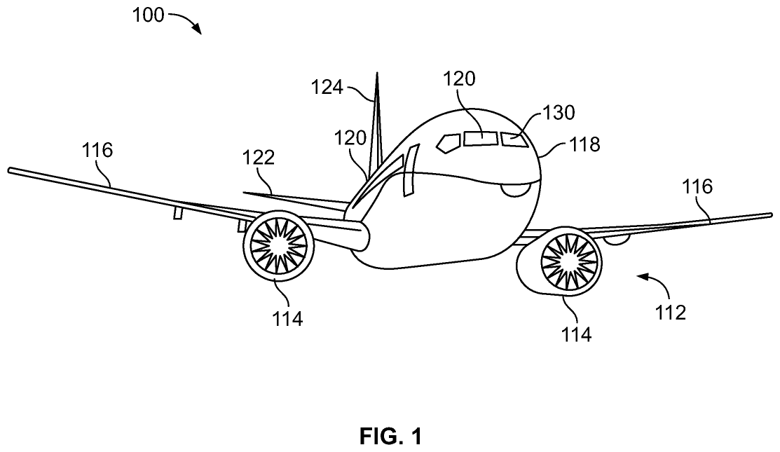

FIG. 1 illustrates a perspective front view of an aircraft 100, according to an example of the present disclosure. The aircraft 100 includes a propulsion system 112 that includes engines 114, for example. Optionally, the propulsion system 112 may include more engines 114 than shown. The engines 114 are carried by wings 116 of the aircraft 100. In other examples, the engines 114 may be carried by a fuselage 118 and/or an empennage 120. The empennage 120 may also support horizontal stabilizers 122 and a vertical stabilizer 124.

The fuselage 118 of the aircraft 100 defines an internal cabin 130, which includes a flight deck or cockpit, one or more work sections (for example, galleys, personnel carry-on baggage areas, and the like), one or more passenger sections (for example, first class, business class, and coach sections), one or more lavatories, and/or the like.

Alternatively, instead of an aircraft, examples of the present disclosure may be used with various other vehicles, such as automobiles, buses, locomotives and train cars, watercraft, and the like.

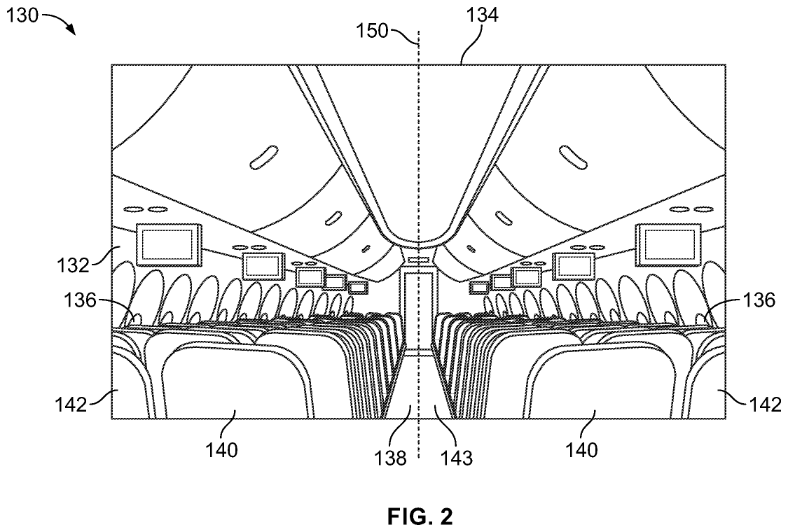

FIG. 2 illustrates a perspective interior view of an internal cabin 130 of an aircraft, according to an example of the present disclosure. The internal cabin 130 includes outboard walls 132 and a ceiling 134. Windows 136 may be formed within the outboard walls 132. A floor 138 supports rows of seats 140. As shown in FIG. 2, a row 142 may include three seats 140 on either side of an aisle 143. However, the row 142 may include more or fewer seats 140 than shown. Additionally, the internal cabin 130 may include more aisles than shown.

As used herein, the term “outboard” means a position that is further away from a central longitudinal plane 150 of the internal cabin 130 as compared to another component. The term “inboard” means a position that is closer to the central longitudinal plane 150 of the internal cabin 130 as compared to another component.

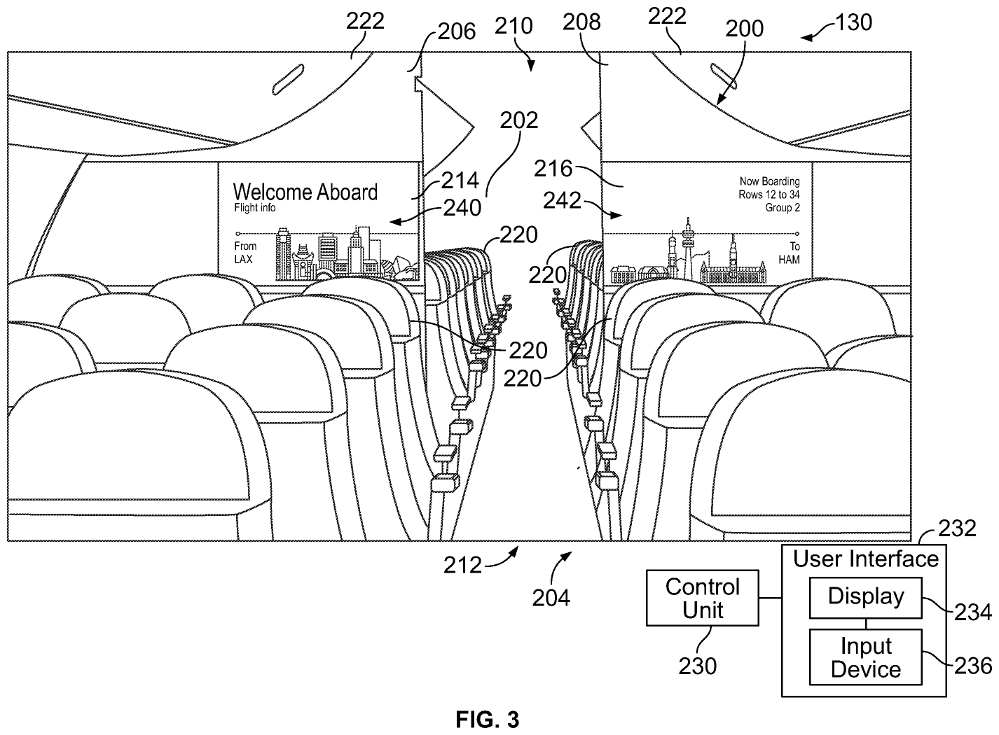

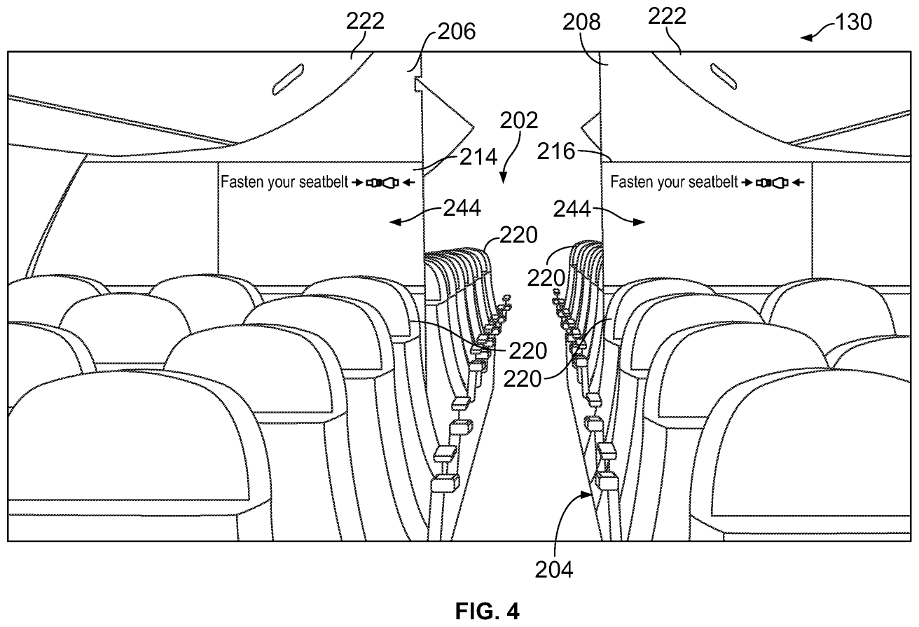

FIG. 3 illustrates a perspective view of a divider system 200 having electronic screens 214 and 216 showing electronic content within an internal cabin 130 of an aircraft, according to an example of the present disclosure. FIG. 4 illustrates a perspective view the divider system 200 having the electronic screens 214 and 216 showing different electronic content within the internal cabin 130 of FIG. 3. Referring to FIGS. 3 and 4, the internal cabin 130 includes the divider system 200, which separates a first section 202 (such as a first or business class section) from a second section 204 (such as an economy section). In general, the divider system 200 separates different class sections of the internal cabin 130 from one another. That is, the divider system 200 provides a defined and unmistakable separating barrier between two different sections.

The divider system 200 includes a pair of opposed vertical walls 206 and 208 separated by a passage 210, through which an aisle 212 passes. The walls 206 and 208 are on opposite sides of the aisle 212. The walls 206 and 208 can be coplanar with one another.

A display, such as the electronic screen 214 and/or 216, is mounted on each wall 206 and 208, respectively. For example, the electronic screen 214 is mounted on the wall 206, and the electronic screen 216 is mounted on the wall 208. In at least one example, each of the electronic screens 214 and 216 is installed within a reciprocal opening extending through both sides of the walls 206 and 208. As such, the electronic screens 214 and 216 are visible through both sides of the walls 206 and 208, respectively. As another example, the electronic screens 214 and 216 can be secured to one side of a wall 206 and 208, respectively, and coupled to a camera having an optical lens or the like that passes through the other side of the wall 206 or 208. In this manner, the camera can acquire video and/or images, such as in relation to an end of the internal cabin 130, which can be displayed on the electronic screen 214 or 216.

Each of the electronic screens 214 and 216 can be an electronic monitor, television, touchscreen interface, and/or the like. In at least one example, the electronic screens 214 and 216 are transparent digital display screens. Optionally, the divider system 200 may include only a single electronic screen 214 or 216. For example, the divider system 200 may include the electronic screen 214 on the wall 206, but not the electronic screen 216 on the wall 208. As another example, the divider system 200 may include the electronic screen 216 on the wall 208, but not the electronic screen 214 on the wall 206. As another example, one or both walls 206 and/or 208 can include multiple electronic screens.

In at least one example, the walls 206 and 208 are disposed in the internal cabin 130 between rows of seats 220. The walls 206 and 208 can extend upwardly form a floor to overhead stowage bins 222, and/or a ceiling within the internal cabin 130. As another example, the walls 206 and 208 may not extend to the overhead stowage bins 222 or the ceiling.

The electronic screens 214 and 216 can be used to display various types of electronic content in real time. Further, the electronic screens 214 and 216 can be operated and controlled, such as by a control unit 230, to be transparent during taxi, take off, and landing to meet regulatory requirements (such as promulgated by the United States Federal Aviation Administration (FAA)) that require a flight attendant to be visible to passengers along the length of the internal cabin.

In at least one example, the divider system 200 also includes the control unit 230 in communication with a user interface 232, such as through one or more wired or wireless connections. The user interface 232 includes a display 234 in communication with an input device 236, such as through one or more wired or wireless connections. In at least one example, the display 234 is an electronic device configured to electronically show images, videos, text, and/or the like. The display 234 can be a monitor, screen, television, touchscreen, and/or the like. The input device 236 can include a keyboard, mouse, stylus, touchscreen interface (that is, the input device 236 can be integral with the display 234), and/or the like. The display 234 is configured to show visual graphics, videos, text, and/or the like.

The control unit 230 and the user interface 232 can be located within the internal cabin 130, such as within a galley or attendant area. As another example, the control unit 230 and the user interface 232 can be in a flight deck or cockpit of the aircraft. In at least one example, the control unit 230 and the user interface 232 are part of a computer workstation within the internal cabin 130. As another example, the control unit 230 and the user interface 232 can be part of a handheld device, such as an electronic tablet, a smartphone, or the like.

The control unit 230 is further in communication with the electronic screens 214 and 216, such as through one or more wired or wireless connections. An individual can operate the electronic screens 214 and 216 to show content including various messages, graphics, and the like on the electronic screens 214 and 216 through inputs of the user interface 232, which are provided to the electronic screens 214 and 216 through the control unit 230, which controls operation of the electronic screens 214 and 216.

For example, as shown in FIG. 3, the control unit 230 can operate the electronic screens 214 and 216 to show initial boarding messages, such as a boarding welcome 240, and boarding status 242. As another example, as shown in FIG. 4, the control unit 230 can operate the electronic screens 214 and 216 to show instructions during flight, such as seatbelt fastening instructions 244 before the aircraft departs an airport.

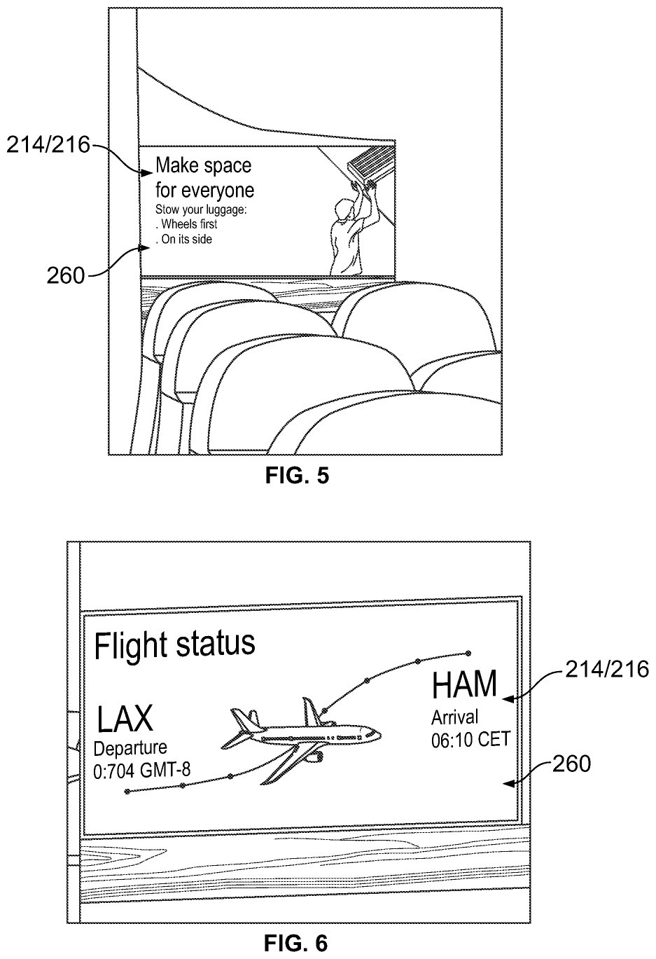

FIG. 5 illustrate a perspective front view of the electronic screen 214 (or the electronic screen 216) showing a message, according to an example of the present disclosure. As shown, the message can be a luggage stowage suggestion 260.

FIG. 6 illustrate a perspective front view of the electronic screen 214 (or the electronic screen 216) showing a message, according to an example of the present disclosure. As shown, the message can be a flight status indication 262.

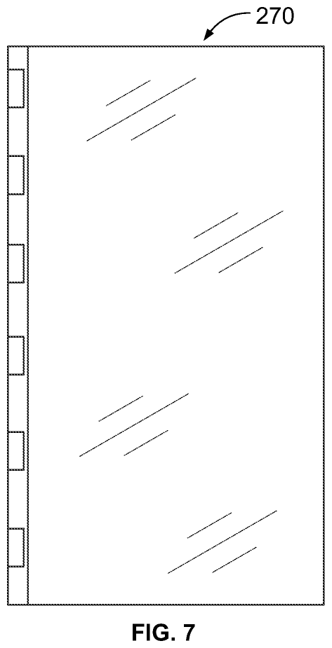

FIG. 7 illustrates a perspective view of an electronic screen 270, according to an example of the present disclosure. The electronic screen 270 is an example of the electronic screens 214 and 216. The electronic screen 270 is transparent in that it is clear and visible therethrough, such as when in a transparent mode of operation. In at least one example, the electronic screen 270 is an ultra-thin, lightweight transparent organic light-emitting diode (OLED) screen. As a further example, the electronic screen 270 is sized and shaped to be easily secured to and removed from (such as for maintenance) a wall 206 or 208 of the divider system 200 (shown in FIGS. 3-6).

Referring to FIGS. 3-7, the electronic screens 214 and 216 are mounted on the walls 206 and 208, respectively. The control unit 230 is configured to operate the electronic screens 214 and 216. In this manner, the electronic screens 214 and 216 can be controlled in real time, and based on phases of flight of the aircraft, for example.

The electronic screens 214 and 216 can be used to provide content management and content delivery. Passengers benefit from contextual content, as shown on the electronic screes 214 and 216, based on destination, time of day and weather, and the like, which is further enhanced by a premium monument design. The control unit 230 operates the electronic screens 214 and 216 to provide real-time contextual content, while also aiding cabin operations for the crew. For example, during boarding, the electronic screens 214 and 216 can present welcoming, informative guidance. During takeoff/taxi/landing, the electronic screens 214 and 216 can offer a direct, transparent view therethrough for the crew to see without impediment. That is, the control unit 230 can operate the electronic screens 214 and 216 to selectively switch between an opaque mode (in which electronic content is shown on an opaque screen that may not provide a clear view therethrough), and a transparent mode (in which the electronic screens 214 and 216 are clear to allow viewing therethrough). Electronic content can also be shown on the electronic screens 214 and 216 in the transparent mode. During flight, the electronic screens 214 and 216 can be operated to create unique and desirable environments for all classes. As passengers disembark the internal cabin 130, the electronic screens 214 and 216 can provide branding opportunities inviting passengers to fly again.

When the electronic screens 214 and 216 are in the transparent mode, the electronic screens 214 and 216 provide a clear view therethrough. As such, a flight attendant, for example, can maintain a line of sight from a forward end of the internal cabin to an area behind the divider system 200 (which would otherwise be impossible with a solid wall, for example).

The electronic screens 214 and 216 can be used to show important information regarding various event, such as safety announcements from the crew. In this manner, the electronic screens 214 and 216 can operate as virtual flight assistants. The electronic screens 214 and 216 can show text, graphics, and/or videos regarding seat belt fastening, moving seats to upright positions, and the like.

As used herein, the term “control unit,” “central processing unit,” “CPU,” “computer,” or the like may include any processor-based or microprocessor-based system including systems using microcontrollers, reduced instruction set computers (RISC), application specific integrated circuits (ASICs), logic circuits, and any other circuit or processor including hardware, software, or a combination thereof capable of executing the functions described herein. Such are exemplary only, and are thus not intended to limit in any way the definition and/or meaning of such terms. For example, the control unit 230 may be or include one or more processors that are configured to control operation, as described herein.

The control unit 230 is configured to execute a set of instructions that are stored in one or more data storage units or elements (such as one or more memories), in order to process data. For example, the control unit 230 may include or be coupled to one or more memories. The data storage units may also store data or other information as desired or needed. The data storage units may be in the form of an information source or a physical memory element within a processing machine.

The set of instructions may include various commands that instruct the control unit 230 as a processing machine to perform specific operations such as the methods and processes of the various examples of the subject matter described herein. The set of instructions may be in the form of a software program. The software may be in various forms such as system software or application software. Further, the software may be in the form of a collection of separate programs, a program subset within a larger program, or a portion of a program. The software may also include modular programming in the form of object-oriented programming. The processing of input data by the processing machine may be in response to user commands, or in response to results of previous processing, or in response to a request made by another processing machine.

The diagrams of examples herein may illustrate one or more control or processing units, such as the control unit 230. It is to be understood that the processing or control units may represent circuits, circuitry, or portions thereof that may be implemented as hardware with associated instructions (e.g., software stored on a tangible and non-transitory computer readable storage medium, such as a computer hard drive, ROM, RAM, or the like) that perform the operations described herein. The hardware may include state machine circuitry hardwired to perform the functions described herein. Optionally, the hardware may include electronic circuits that include and/or are connected to one or more logic-based devices, such as microprocessors, processors, controllers, or the like. Optionally, the control unit 230 may represent processing circuitry such as one or more of a field programmable gate array (FPGA), application specific integrated circuit (ASIC), microprocessor(s), and/or the like. The circuits in various examples may be configured to execute one or more algorithms to perform functions described herein. The one or more algorithms may include aspects of examples disclosed herein, whether or not expressly identified in a flowchart or a method.

As used herein, the terms “software” and “firmware” are interchangeable, and include any computer program stored in a data storage unit (for example, one or more memories) for execution by a computer, including RAM memory, ROM memory, EPROM memory, EEPROM memory, and non-volatile RAM (NVRAM) memory. The above data storage unit types are exemplary only, and are thus not limiting as to the types of memory usable for storage of a computer program.

Further, the disclosure comprises examples according to the following clauses:

Clause 1. A divider system configured to separate a first section from a second section within an internal cabin of a vehicle, the divider system comprising:
one or more walls; and
one or more electronic screens secured to the one or more walls, wherein the one or more electronic screens are transparent and configured to show electronic content thereon.

Clause 2. The divider system of Clause 1, wherein the one or more electronic screens comprise a transparent organic light-emitting diode (OLED) screen.

Clause 3. The divider system of Clauses 1 or 2, wherein the one or more walls comprise a first wall and a second wall, and wherein the one or more electronic screens comprise a first electronic screen coupled to the first wall, and a second electronic screen coupled to the second wall.

Clause 4. The divider system of Clause 3, wherein each of the first electronic screen and the second electronic screens is a transparent organic light-emitting diode (OLED) screen.

Clause 5. The divider system of Clauses 3 or 4, wherein the first wall and the second wall are configured to be separated by an aisle within the internal cabin.

Clause 6. The divider system of any of Clauses 1-5, wherein the one or more electronic screens are selectively switchable between a transparent mode and an opaque mode.

Clause 7. The divider system of any of Clauses 1-6, wherein the first section is a first class section or a business class section, and the second section is the business class section or an economy section.

Clause 8. The divider assembly of any of Clauses 1-7, wherein the one or more walls are configured to extend to one or both of an overhead stowage bin or a ceiling within the internal cabin.

Clause 9. The divider assembly of any of Clauses 1-8, further comprising a control unit in communication with the one or more electronic screens, wherein the control unit is configured to control operation of the one or more electronic screens to display various types of the electronic content.

Clause 10. The divider system of Clause 9, wherein the vehicle is an aircraft.

Clause 11. The divider assembly of Clause 10, wherein the control unit is configured to control the one or more electronic screens based on phases of a flight of the aircraft.

Clause 12. An aircraft comprising:
an internal cabin having a first section and a section; and
a divider system within the internal cabin, wherein the divider system separates the first section from the second section, the divider system comprising:
   one or more walls; and
   one or more electronic screens secured to the one or more walls, wherein the one or more electronic screens are transparent and configured to show electronic content thereon.

Clause 13. The aircraft of Clause 12, wherein the one or more walls comprise a first wall and a second wall, and wherein the one or more electronic screens comprise a first electronic screen coupled to the first wall, and a second electronic screen coupled to the second wall.

Clause 14 The aircraft of Clause 13, wherein each of the first electronic screen and the second electronic screens is a transparent organic light-emitting diode (OLED) screen.

Clause 15. The aircraft of Clauses 13 or 14, wherein the first wall and the second wall are separated by an aisle within the internal cabin.

Clause 16. The aircraft of any of Clauses 12-15, wherein the one or more electronic screens are selectively switchable between a transparent mode and an opaque mode, wherein the electronic screens in the transparent mode provide a clear line of sight therethrough.

Clause 17. The aircraft of any of Clauses 12-16, wherein the first section is a first class section or a business class section, and the second section is the business class section or an economy section.

Clause 18. The aircraft of any of Clauses 12-17, wherein the one or more walls extend to one or both of an overhead stowage bin or a ceiling within the internal cabin.

Clause 19. The aircraft of any of Clauses 12-18, further comprising a control unit in communication with the one or more electronic screens, wherein the control unit is configured to control operation of the one or more electronic screens to display various types of the electronic content, and wherein the control unit is configured to control the one or more electronic screens based on phases of a flight of the aircraft.

Clause 20. An aircraft comprising:
an internal cabin having a first section and a section, wherein the first section is a first class section or a business class section, and the second section is the business class section or an economy section; and
a divider system within the internal cabin, wherein the divider system separates the first section from the second section, the divider system comprising:
   a first wall extending to one or both of a first overhead stowage bin or a ceiling within the internal cabin;
   a first transparent organic light-emitting diode (OLED) screen coupled to the first wall, wherein the first transparent OLED screen is configured to show first electronic content thereon, and wherein the first transparent OLED screen is selectively switchable between a first transparent mode and a first opaque mode;
   a second wall separated from the first wall by an aisle, wherein the second wall extends to one or both of a second overhead stowage bin or the ceiling within the internal cabin;
   a second transparent OLED screen coupled to the second wall, wherein the second transparent OLED screen is configured to show second electronic content thereon, and wherein the second transparent OLED screen is selectively switchable between a second transparent mode and a second opaque mode; and
   a control unit in communication with the first transparent OLED screen and the second transparent OLED screen, wherein the control unit is configured to control operation of the first transparent OLED screen and the second transparent OLED screen to display various types of the first electronic content and the second electronic content, respectively, and wherein the control unit is configured to control the first transparent OLED screen and the second transparent OLED screen based on phases of a flight of the aircraft.

As described herein, examples of the present disclosure improved systems and methods for dividing sections within an internal cabin of a vehicle, such as a commercial aircraft. Further, examples of the present disclosure provide systems and methods for providing information to passengers in different sections of an internal cabin of a vehicle.

While various spatial and directional terms, such as top, bottom, lower, mid, lateral, horizontal, vertical, front and the like can be used to describe embodiments of the present disclosure, it is understood that such terms are merely used with respect to the orientations shown in the drawings. The orientations can be inverted, rotated, or otherwise changed, such that an upper portion is a lower portion, and vice versa, horizontal becomes vertical, and the like.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

It is to be understood that the above description is intended to be illustrative, and not restrictive. For example, the above-described embodiments (and/or aspects thereof) can be used in combination with each other. In addition, many modifications can be made to adapt a particular situation or material to the teachings of the various embodiments of the disclosure without departing from their scope. While the dimensions and types of materials described herein are intended to define the parameters of the various embodiments of the disclosure, the embodiments are by no means limiting and are exemplary embodiments. Many other embodiments will be apparent to those of skill in the art upon reviewing the above description. The scope of the various embodiments of the disclosure should, therefore, be determined with reference to the appended claims, along with the full scope of equivalents to which such claims are entitled. In the appended claims and the detailed description herein, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112 (f), unless and until such claim limitations expressly use the phrase “means for” followed by a statement of function void of further structure.

This written description uses examples to disclose the various embodiments of the disclosure, including the best mode, and also to enable any person skilled in the art to practice the various embodiments of the disclosure, including making and using any devices or systems and performing any incorporated methods. The patentable scope of the various embodiments of the disclosure is defined by the claims, and can include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

What is claimed is:

1. A divider system configured to separate a first section from a second section within an internal cabin of a vehicle, the divider system comprising:
one or more walls; and
one or more electronic screens secured to the one or more walls, wherein the one or more electronic screens are transparent and configured to show electronic content thereon.

2. The divider system of claim 1, wherein the one or more electronic screens comprise a transparent organic light-emitting diode (OLED) screen.

3. The divider system of claim 1, wherein the one or more walls comprise a first wall and a second wall, and wherein the one or more electronic screens comprise a first electronic screen coupled to the first wall, and a second electronic screen coupled to the second wall.

4. The divider system of claim 3, wherein each of the first electronic screen and the second electronic screens is a transparent organic light-emitting diode (OLED) screen.

5. The divider system of claim 3, wherein the first wall and the second wall are configured to be separated by an aisle within the internal cabin.

6. The divider system of claim 1, wherein the one or more electronic screens are selectively switchable between a transparent mode and an opaque mode.

7. The divider system of claim 1, wherein the first section is a first class section or a business class section, and the second section is the business class section or an economy section.

8. The divider assembly of claim 1, wherein the one or more walls are configured to extend to one or both of an overhead stowage bin or a ceiling within the internal cabin.

9. The divider assembly of claim 1, further comprising a control unit in communication with the one or more electronic screens, wherein the control unit is configured to control operation of the one or more electronic screens to display various types of the electronic content.

10. The divider system of claim 9, wherein the vehicle is an aircraft.

11. The divider assembly of claim 10, wherein the control unit is configured to control the one or more electronic screens based on phases of a flight of the aircraft.

12. An aircraft comprising:
an internal cabin having a first section and a section; and
a divider system within the internal cabin, wherein the divider system separates the first section from the second section, the divider system comprising:
one or more walls; and
one or more electronic screens secured to the one or more walls, wherein the one or more electronic screens are transparent and configured to show electronic content thereon.

13. The aircraft of claim 12, wherein the one or more walls comprise a first wall and a second wall, and wherein the one or more electronic screens comprise a first electronic screen coupled to the first wall, and a second electronic screen coupled to the second wall.

14. The aircraft of claim 13, wherein each of the first electronic screen and the second electronic screens is a transparent organic light-emitting diode (OLED) screen.

15. The aircraft of claim 13, wherein the first wall and the second wall are separated by an aisle within the internal cabin.

16. The aircraft of claim 12, wherein the one or more electronic screens are selectively switchable between a transparent mode and an opaque mode, wherein the electronic screens in the transparent mode provide a clear line of sight therethrough.

17. The aircraft of claim 12, wherein the first section is a first class section or a business class section, and the second section is the business class section or an economy section.

18. The aircraft of claim 12, wherein the one or more walls extend to one or both of an overhead stowage bin or a ceiling within the internal cabin.

19. The aircraft of claim 12, further comprising a control unit in communication with the one or more electronic screens, wherein the control unit is configured to control operation of the one or more electronic screens to display various types of the electronic content, and wherein the control unit is configured to control the one or more electronic screens based on phases of a flight of the aircraft.

20. An aircraft comprising:
an internal cabin having a first section and a section, wherein the first section is a first class section or a business class section, and the second section is the business class section or an economy section; and
a divider system within the internal cabin, wherein the divider system separates the first section from the second section, the divider system comprising:
a first wall extending to one or both of a first overhead stowage bin or a ceiling within the internal cabin;
a first transparent organic light-emitting diode (OLED) screen coupled to the first wall, wherein the first transparent OLED screen is configured to show first electronic content thereon, and wherein the first transparent OLED screen is selectively switchable between a first transparent mode and a first opaque mode;
a second wall separated from the first wall by an aisle, wherein the second wall extends to one or both of a second overhead stowage bin or the ceiling within the internal cabin;
a second transparent OLED screen coupled to the second wall, wherein the second transparent OLED screen is configured to show second electronic content thereon, and wherein the second transparent OLED screen is selectively switchable between a second transparent mode and a second opaque mode; and
a control unit in communication with the first transparent OLED screen and the second transparent OLED screen, wherein the control unit is configured to control operation of the first transparent OLED screen and the second transparent OLED screen to display various types of the first electronic content and the second electronic content, respectively, and wherein the control unit is configured to control the first transparent OLED screen and the second transparent OLED screen based on phases of a flight of the aircraft.
